(19) United States
(12) Patent Application Publication
(10) Pub. No.: US 2007/0262722 A1
(43) Pub. Date: Nov. 15, 2007

(54) Method and Circuit for Supplying a Hot Cathode Fluorescent Lamp

(75) Inventors: Godfried Cornelius Gerardus Maria Manders, Eindhoven (NL); Renatus Willem Clemens Van Der Veeken, Eindhoven (NL); Lars R.C. Waumans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,081

(22) PCT Filed: Sep. 8, 2005
(86) PCT No.: PCT/IB05/52941

§ 371 Date: Mar. 12, 2007

(30) Foreign Application Priority Data
Sep. 15, 2004 (EP) 04104450.4

(51) Int. Cl. H05B 41/36

(52) U.S. Cl. 315/107

(57) ABSTRACT

A hot cathode fluorescent lamp (2) comprises a vessel (4) containing two electrodes (8, 9) at a distance from each other with each electrode having two connection leads (10, 11, 12, 13) extending to the outside of the vessel. Across each electrode a heating voltage is applied to have a heating current (I_{H1}, I_{H2}) flowing through the electrode. Across 5 the electrodes a discharge voltage is applied to have a discharge or lamp current (I_{L}) flowing through the lamp. At least for one electrode the lamp current is divided into partial lamp currents (I_{L1}, I_{L2}, I_{L3}, I_{L4}). A control circuit (32) is arranged to control the partial lamp currents, such that one of the partial lamp currents is greater, possibly maximum when taking a reference value for the heating current in account, than the other partial lamp current.

### FIELD OF THE INVENTION

The invention relates to a method for supplying a hot cathode fluorescent lamp according to the preamble of claim 1. The invention also relates to a circuit for supplying a hot cathode fluorescent lamp according to the preamble of claim 4.

### BACKGROUND OF THE INVENTION

A method and a circuit of the above type is disclosed by U.S. Pat. No. 6,300,719. According to this prior art each heating voltage source is controllable, the discharge voltage source is controllable and the discharge voltage is applied to one lead of each electrode only. The heating and lamp voltages and currents are measured to identify the type of the lamp to therewith control said voltages to optimum values for operating the lamp.

During operation of the lamp with a lamp current flowing through the lamp, because of the resistance of the electrode, a discharge voltage at one lead of the electrode where the discharge voltage is applied to is higher than at the other lead of the electrode. Consequently, an amount of lamp current through a portion of the electrode near said one lead and then through the lamp will be higher than near the other lead and the temperature of said portion will be higher than near the other lead. Therefore such portion of the electrode is often called a hot spot.

During operation of the lamp relatively hot electrode portions may be depleted by evaporation and relatively cold electrode portions may be depleted by sputtering. Because of the depletion the resistance of the electrode increases along its entire length but more at its colder portions. Consequently, in time the hot spot moves away from the lead of the electrode where the discharge voltage is applied to. A larger portion of the electrode will conduct the lamp current then, giving raise to more evaporation of material of said portion of the electrode, and as a result a higher resistance of the electrode. If the currents are controlled to be constant the higher resistance will increase the temperature and the evaporation, and so on.

The inventors found, that, even without control of the currents, the moving of the hot spot is an important cause which reduces the lifetime of the lamp. This is very disadvantages in cases where it is difficult or costly to replace such a reduced performing lamp. In particular, when used as back light in flat screen television sets it is desired to extend the lifetime of hot cathode fluorescent lamps.

### OBJECT OF THE INVENTION

It is an object of the invention to solve the drawbacks of the method and circuit for supplying hot cathode fluorescent lamps of the type described.

### SUMMARY OF THE INVENTION

The above object of the invention is achieved by a method as described in claim 1.

Accordingly, by controlling the partial lamp currents the location of the hot spot of an electrode can be controlled, preferably close to the lead where the discharge voltage is applied to. Tests carried out by the inventors proved that by doing so the lifetime of the lamp is increased.

The above object of the invention is achieved also by a circuit as described in claim 4.

### BRIEF DESCRIPTION OF THE DRAWINGS

The invention will become more gradually apparent from the following exemplary description in connection with the accompanying drawing. In the drawing there is shown:

FIG. 1 a schematic diagram of an embodiment of a circuit according to the invention.

### DETAILED DESCRIPTION OF A PREFERRED EMBODIMENT

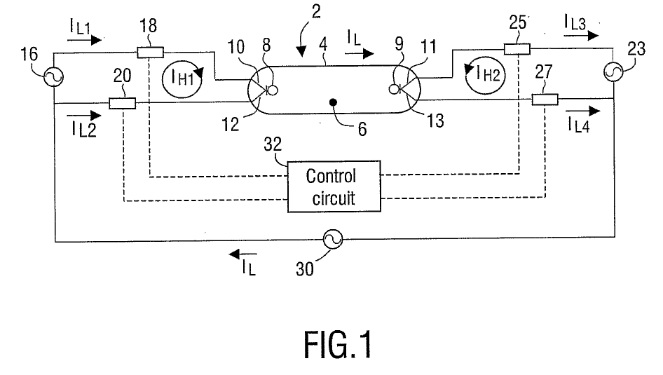

The diagram of FIG. 1 shows a hot cathode fluorescent lamp 2. Lamp 2 comprises a vessel 4, which has been evacuated and then filled with some gas, as indicated by a dot 6. Inside the vessel 4 there are arranged two electrodes 8 and 9 at a distance from each other. In practice the vessel 4 is tubular and the electrodes 8 and 9 are arranged at the ends of the tubular vessel 4. Each of the electrodes 8 and 9 has a first lead 10, 11, respectively, and a second lead 12, 13, respectively. The leads 10 to 13 are extended to the outside of the vessel 4.

Apart from lamp 2, the diagram of FIG. 1 shows a supply circuit for supplying lamp 2.

The supply circuit comprises three loops, which each contain a power source. Here it is assumed that voltage sources with some impedance are used.

A first loop of said loops comprises a heating voltage source 16. One terminal of heating voltage source 16 is connected to the first lead 10 of electrode 8 via an impedance 18. The other terminal of heating voltage source 16 is connected to the second lead 12 of electrode 8 via an impedance 20.

A second loop of said loops comprises a heating voltage source 23. One terminal of heating voltage source 23 is connected to the first lead 11 of electrode 9 via an impedance 25. The other terminal of heating voltage source 23 is connected to the second lead 13 of electrode 9 via an impedance 27.

A third loop of said loops comprises a discharge voltage source 30 plus lamp 2 and the components 8 to 27 of the first and second loops.

As indicated in FIG. 1, the heating voltages and the discharge voltage can be alternating voltages with a high frequency, such as 50 kHz, as is common practice. However, the invention is not limited to the use of alternating voltages (or currents).

The impedances 18, 20, 25 and 27 are controllable impedances. For example, each of the impedances 18, 20, 25 and 27 may be composed by several impedances, each of which may be connected to or disconnected from the remaining of the circuit shown in FIG. 1 by the use of switches. Each of the impedances 18, 20, 25 and 27 may also comprise a coil, of which the impedance can be changed by changing a magnitude of a DC voltage, which is applied to the coil. Each of the impedances 18, 20, 25 and 27 may also be a frequency dependent component, of which the impedance can be controlled by controlling the frequency of one or more of said voltage sources 16, 23 and 30.

The supply circuit further comprises a control circuit 32. Although not shown, the control circuit 32 receives voltage and current measurement signals of voltages and currents occurring in the supply circuit. In particular there are measured heating current I_{H1} through the first (heating) loop, heating current I_{H2} through the second (heating) loop, partial lamp current I_{L1} through impedance 18, partial lamp current I_{L2} through impedance 20, partial lamp current I_{L3} through impedance 25, partial lamp current I_{L4} through impedance 27 and, possibly, lamp current I_{L} (=I_{L1}+I_{L2}=I_{L3}+I_{L4}) through the third (discharge) loop.

Control circuit 32 is arranged to control the impedances 18, 20, 25, 27 dependent on values of the measured currents, such that a partial lamp current to one lead of an electrode 8, 9 is greater than the partial lamp to the other lead of the same electrode. Thus, four combinations of magnitudes of partial lamp currents are possible: (I_{L1}>I_{L2} or I_{L1}<I_{L2}) and (I_{L3}>I_{L4} or I_{L3}<I_{L4}).

Preferably, the control circuit 32 controls the impedances 18, 20, 25, 27 such that the greater partial lamp currents are maximum taking the heating currents I_{H1} and I_{H2} into account. As a result, the location hot spot of each electrode can be kept close to one lead of the electrode and at the same time a certain heating of the electrode by the heating current, which may change by changing said impedances, can be maintained.

The use of the controllable impedances also allows the control circuit 32 to control the impedances 18, 20, 25, 27 such that values of the heating currents I_{H1} and I_{H2} and the lamp current I_{L} are identical, or almost identical, to respective reference values. Consequently, by changing the reference values, the supply circuit can be adapted to different types of lamps and to control the light output power.

With an arrangement of the supply circuit for a hot cathode fluorescent lamp with the use and control of partial lamp currents as described above, the lifetime of the lamp 2 is increased and performances are improved.

It is noted that the invention is not limited to the embodiment as shown in the drawing and as described above, but only by the claims as follow. For example, the division of the lamp current I_{L} into partial lamp currents towards (or from) one electrode 8, 9 does not require to do the same for the other electrode, i.e. the loop for the other electrode may be void of controllable impedances.

1. A method for supplying a hot cathode fluorescent lamp, the lamp comprising a vessel containing a pair of electrodes at a distance from each other, each electrode having two connection leads extending to the outside of the vessel, in which a heating voltage is supplied across each electrode, a discharge voltage is applied across the electrodes to have a lamp current flowing through the lamp, and a current through a lead of an electrode is controlled, characterized in that, for at least one electrode the lamp current is divided into two partial lamp currents which are supplied to the leads of the at least one electrode, respectively, and the partial lamp currents are controlled such that one of the partial lamp currents is greater than the other partial lamp current.

2. Method according to claim 1, characterized in that, together with the control of the partial lamp currents a heating current, generated by the heating voltage, is controlled towards a reference value.

3. Method according to claim 1, characterized in that, the greatest partial lamp current is controlled to be maximum while keeping the heating current at a reference value.

4. A circuit for supplying a hot cathode fluorescent lamp, the lamp comprising a vessel containing a pair of electrodes at a distance from each other, each electrode having two connection leads extending to the outside of the vessel, a pair of heating voltage sources, which are connected to apply heating voltages across both electrodes, respectively, a discharge voltage source, which is connected to apply a discharge voltage across the electrodes to have a lamp current flowing through the lamp, and a control circuit for controlling a current through a lead of an electrode, characterized in that, of at least one electrode the leads are connected to a terminal of the discharge voltage source via two controllable impedances, so that the lamp current is divided into partial lamp currents, which are supplied to the leads of the at least one electrode, respectively, and the control circuit is arranged to control the controllable impedances, such that one of the partial lamp currents is greater than the other partial lamp current.

5. Circuit according to claim 4, characterized in that, the control circuit is arranged to control the controllable impedances, such that a heating current, which is generated by the heating voltage, is controlled towards a reference value.

6. Circuit according to claim 4, characterized in that, the control circuit is arranged to control the controllable impedances, such that the greatest partial lamp current is controlled to be maximum while keeping the heating current at a reference value
